(19) United States
(12) Patent Application Publication
(10) Pub. No.: US 2021/0318510 A1
(43) Pub. Date: Oct. 14, 2021

(54) LENS MODULE AND ELECTRONIC DEVICE HAVING THE SAME

(71) Applicant: TRIPLE WIN TECHNOLOGY(SHENZHEN) CO.LTD., Shenzhen (CN)

(72) Inventors: JIAN-CHAO SONG, Shenzhen (CN); SHENG-JIE DING, Shenzhen (CN); SHIN-WEN CHEN, New Taipei (TW); JING-WEI LI, Shenzhen (CN)

(21) Appl. No.: 16/860,910

(22) Filed: Apr. 28, 2020

(30) Foreign Application Priority Data
Apr. 13, 2020 (CN) 202010284907.0

(51) Int. Cl. G02B 7/02; H04N 5/225

(52) U.S. Cl. CPC G02B 7/025; G02B 7/028; H04N 5/2254

(57) ABSTRACT

A lens module includes a substrate, a base mounted on the substrate, a lens holder mounted on the base, and a lens mounted in the lens holder. The base is made of metal material by die casting, and an outer surface of the base is darkened by oxidation treatment. The disclosure also provides an electronic device having the lens module.

### FIELD

The subject matter herein generally relates to a lens module and an electronic device having the lens module.

### BACKGROUND

With the development of electronic products, the lens module is an important component in electronic products, and consumers have increasingly higher requirements for the imaging quality of electronic products.

Therefore, there is room for improvement within the art.

### BRIEF DESCRIPTION OF THE DRAWINGS

Implementations of the present disclosure will now be described, by way of embodiments, with reference to the attached figures.

FIG. 1 is a diagram of an embodiment of a lens module.

FIG. 2 is an exploded, diagrammatic view of the lens module of FIG. 1.

FIG. 3 is exploded, diagrammatic view of the lens module of FIG. 1 viewed from another angle.

FIG. 4 is a cross-sectional view of the lens module taken along IV-IV line of FIG. 1.

FIG. 5 is diagram of an embodiment of an electronic device having the lens module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

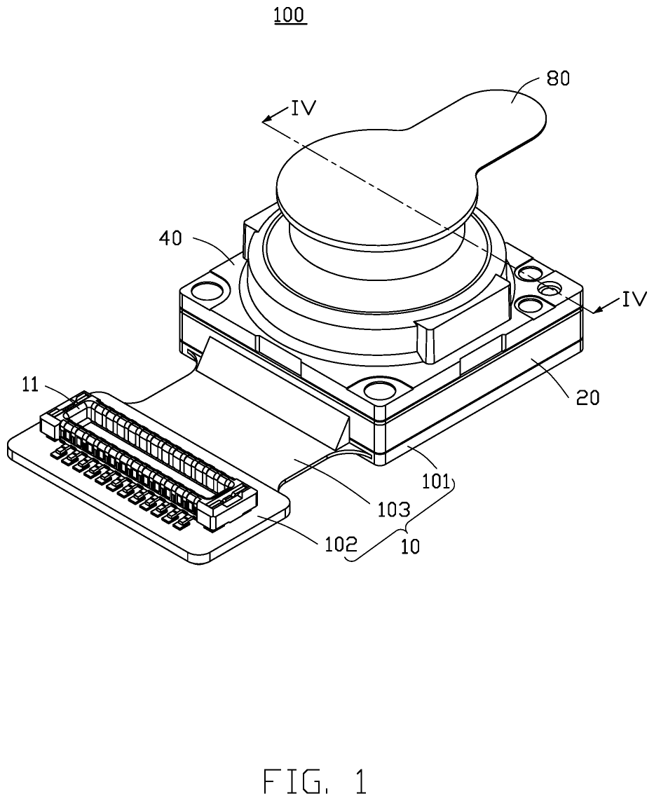

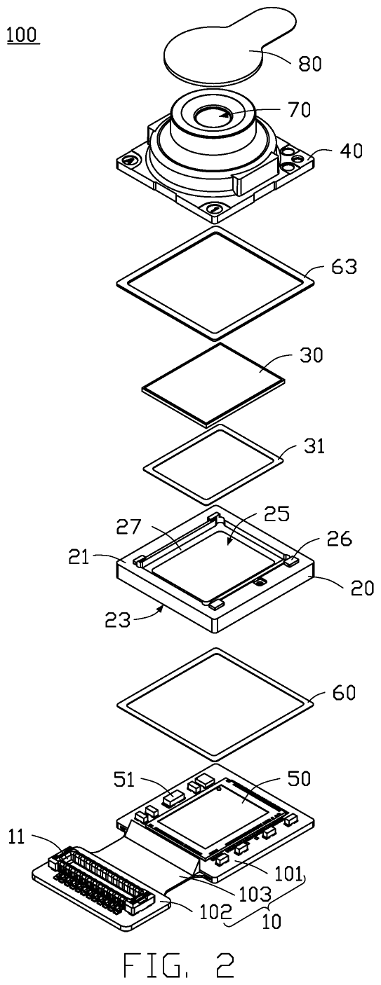

FIG. 1 illustrates an embodiment of a lens module 100. Referring to FIG. 2, the lens module 100 includes a substrate 10, a base 20, a filter 30, a lens holder 40, and a lens 70.

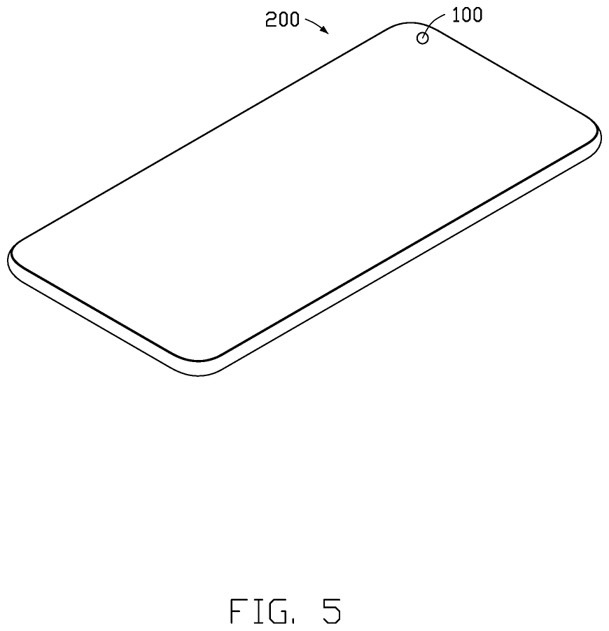

Referring to FIG. 1, in at least one embodiment, the substrate 10 may be a circuit board or ceramic substrate. The circuit board may be a flexible circuit board, a rigid circuit board, a rigid-flexible circuit board, or the like. In an embodiment, the circuit board 10 is a rigid-flexible circuit board including a first rigid portion 101, a second rigid portion 102, a flexible portion 103 connecting the first rigid portion 101 and the second rigid portion 102. At least one electronic connecting element 11 is mounted on a surface of the second rigid portion 102. When the lens module 100 is applied to an electronic device 200 (shown in FIG. 5), the electronic connecting element 11 is configured to transmit signals between the lens module 100 and other components of the electronic device 200. In at least one embodiment, the electronic connecting element 11 may be a connector or a gold finger.

In another embodiment, the electronic connecting element 11 may be mounted on other areas of the substrate 10.

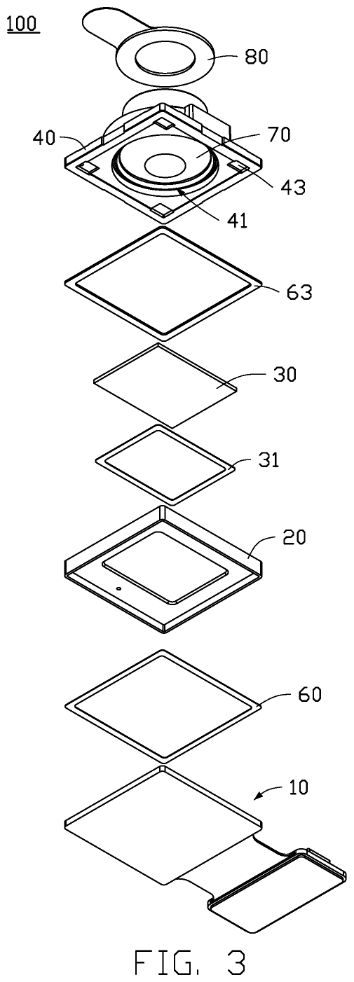

Referring to FIGS. 2 and 3, a photosensitive chip 50 and a plurality of electronic components 51 are mounted on the first rigid portion 101. In at least one embodiment, the photosensitive chip 50 and the plurality of electronic components 51 may be mounted on a same surface of the first rigid portion 101. The electronic components 51 may be at least one of resistors, capacitors, diodes, triodes, relays and electrically erasable programmable read-only memory (EEPROM), or the like.

In at least one embodiment, a thermal conductive adhesive layer (not shown) is provided to bond the photosensitive chip 50 and the substrate 10.

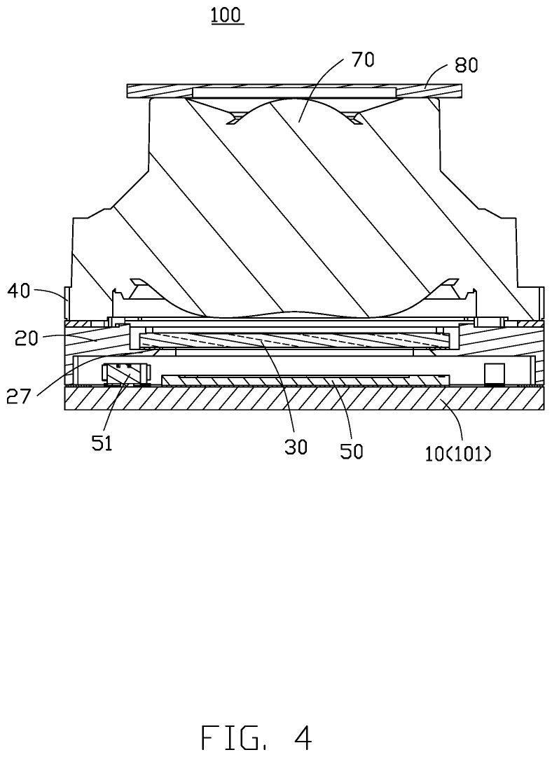

Referring to FIG. 4, the base 20 includes a first surface 21 and a second surface 23 facing away from the first surface 21. A through hole 25 is defined on the base 20 and passes through the first surface 21 and the second surface 23. The base 20 further includes an annular protruding portion 27 extending from an inner surface of the through hole 25 toward a center of the through hole 25.

In at least one embodiment, the shape of the through hole 25 is rectangular. In another embodiment, the through hole 25 may have any other shapes, such as circular or prismatic.

The second surface 23 is fixed to a surface of the first rigid portion 101 where the photosensitive chip 50 is installed. The through hole 25 corresponds the photosensitive chip 50. In at least one embodiment, the second surface 23 is fixed to the substrate 10 through an adhesive layer. In at least one embodiment, the second surface 23 is fixed to the substrate 10 through a thermal conductive adhesive layer 60, thereby facilitating heat conduction between the base 20 and substrate 10 and enhancing the heat dissipation efficiency of the lens module.

The filter 30 is installed on a side of the annular protruding portion 27 facing away from the first rigid portion 101. In at least one embodiment, the filter 30 is fixed to the annular protruding portion 27 through an adhesive layer. In at least one embodiment, the filter 30 is fixed to the annular protruding portion 27 through a thermal conductive adhesive layer 31.

The base 20 is made of metal material with good thermal conductivity and have high strength given by die casting. The metal material may be, but limited to, aluminum alloy, zinc alloy, or iron alloy (such as steel). The metal material is limited so that a heat dissipation capacity of the lens module 100 may be improved, and a thickness of the annular protruding portion 27 along a direction perpendicular to the sidewall of the filter 30 may be reduced, thereby reducing a back focal length of the lens module 100 and a size of the lens module 100 along a direction perpendicular to the sidewall of the filter 30. In at least one embodiment, the thickness of the annular protruding portion 27 can be reduced to 0.10 mm.

The base 20 may be darkened by oxidation treatment, which is beneficial to improve an image resolution of the lens module 100, thereby improving an image quality of the lens module 100 and restraining flare.

In at least one embodiment, the inner surface of the through hole 25 and the annular protruding portion 27 may be treated with plasma treatment to increase a roughness of the inner surface of the through hole 25 and the surfaces of the annular protruding portion 27, which is beneficial to a reflection of light, thereby restraining flare of the lens module 100, and enhancing a reliability of bonding between the filter 30 and the base 20.

In at least one embodiment, the base 20 may further include a plurality of protrusions 26. Each protrusion 26 extends from the first surface 21 in a direction away from the second surface 23. The protrusions 26 are spaced apart from each other. In an embodiment, the number of the protrusions 26 is four, and each protrusion 26 is disposed on the first surface 21 to adjacent to a corner of the through hole 25.

The lens holder 40 is mounted on a side of the base 20 facing away from the substrate 10 through the adhesive layer 63, that is, the lens holder 40 is mounted on the first surface 21 of the base 20. The lens holder 40 includes a receiving hole 41. The receiving hole 41 corresponds to the through hole 25.

Referring to FIG. 3, a plurality of grooves 43 may be defined on the surface of the lens holder 40 which is combined with the base 20. Each protrusion 26 is received in one of the plurality of grooves 43, thereby guiding the lens holder 40 and pre-positioning the lens holder 40 when the lens holder 40 is mounted on the base 20.

The lens 70 is installed in the receiving hole 41 of the lens holder 40. In at least one embodiment, a first thread (not shown) may be formed on an inner surface of the receiving hole 41, and a second thread (not shown) may be formed on an outer surface of the lens 70. The first thread cooperates with the second thread to fix the lens 70 in on the lens holder 40.

In at least one embodiment, the lens module 100 may further include a protective part 80. The protective part 80 cooperates with the lens holder 40 to protect the lens 70, for example, to prevent dust from contaminating the lens 70.

Referring to FIG. 5, the lens module 100 can be applied in an electronic device 200. The electronic device 200 can be a mobile phone, a laptop, a wearable device, a camera, a monitoring device or the like.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lens module comprising:
a substrate;
a base mounted on the substrate;
a lens holder mounted on the base; and
a lens mounted on the lens holder;
wherein the base is made of metal material by die casting, and
an outer surface of the base is darkened by oxidation treatment.

2. The lens module of claim 1, wherein the base is fixed to the substrate through a thermal conductive adhesive layer.

3. The lens module of claim 1, wherein the base comprises a through hole, a first surface and a second surface, wherein
the through hole passes through the first surface and the second surface, the second surface is combined with the substrate, the base further comprises a annular protruding portion extending from an inner surface of the through hole toward a center of the through hole, the inner surface of the through hole and the annular protruding portion are treated with plasma treatment.

4. The lens module of claim 3, wherein the lens module further comprises a filter, and the filter is fixed to the annular protruding portion through a thermal conductive adhesive layer.

5. The lens module of claim 4, wherein a thickness of the annular protruding portion is 0.10 mm.

6. The lens module of claim 1, wherein a plurality of protrusions is formed on a surface of the base facing away from the substrate, the plurality of protrusions are spaced apart from each other, a plurality of grooves corresponding the plurality of protrusions is formed on a surface of the lens holder facing to the base, and each of the plurality of protrusions is received in one of the plurality of grooves.

7. The lens module of claim 1, wherein the metal material is aluminum alloy, zinc alloy or iron alloy.

8. The lens module of claim 1, wherein the lens module further comprises a photosensitive chip, and the photosensitive chip is fixed on the substrate through a thermal conductive adhesive layer.

9. The lens module of claim 1, wherein the substrate comprises a first rigid portion, a second rigid portion, a flexible portion connecting each of the first rigid portion and the second rigid portion, wherein the base is mounted on the first rigid portion, at least one electronic connecting element is mounted on the second rigid portion.

10. An electronic device comprising:
a lens module comprising:
a substrate;
a base mounted on the substrate;
a lens holder mounted on the base; and
a lens mounted on the lens holder;
wherein the base is made of metal material by die casting, and
an outer surface of the base is darkened by oxidation treatment.

11. The electronic device of claim 10, wherein the base is fixed to the substrate through a thermal conductive adhesive layer.

12. The electronic device of claim 10, wherein the base comprises a through hole, a first surface and a second surface, the through hole passes through the first surface and the second surface, wherein
the second surface is combined with the substrate, the base further comprises a annular protruding portion extending from an inner surface of the through hole toward a center of the through hole, the inner surface of the through hole and the annular protruding portion are treated with plasma treatment.

13. The electronic device of claim 12, wherein the lens module further comprises a filter, and the filter is fixed to the annular protruding portion through a thermal conductive adhesive layer.

14. The electronic device of claim 13, wherein a thickness of the annular protruding portion is 0.10 mm.

15. The electronic device of claim 10, wherein a plurality of protrusions is formed on a surface of the base facing away from the substrate, the plurality of protrusions are spaced apart from each other, a plurality of grooves corresponding the plurality of protrusions is formed on a surface of the lens holder facing to the base, and each of the plurality of protrusions is received in one of the plurality of grooves.

16. The electronic device of claim 10, wherein the metal material is aluminum alloy, zinc alloy or iron alloy.

17. The electronic device of claim 10, wherein the lens module further comprises a photosensitive chip, and the photosensitive chip is fixed on the substrate through a thermal conductive adhesive layer.

18. The electronic device of claim 10, wherein the substrate comprises a first rigid portion, a second rigid portion, a flexible portion connecting each of the first rigid portion and the second rigid portion, wherein the base is mounted on the first rigid portion, at least one electronic connecting element is mounted on the second rigid portion.
